(19) United States
(12) Patent Application Publication
(10) Pub. No.: US 2012/0324382 A1
(43) Pub. Date: Dec. 20, 2012

(54) User Interface Adjusting Method and Electronic Device Using the Same

(76) Inventors: Hsin-Yuan Peng, Hsinchu (TW); Jiahn-Rong Gau, Hsinchu (TW)

(21) Appl. No.: 13/225,492

(22) Filed: Sep. 5, 2011

(30) Foreign Application Priority Data
Jun. 16, 2011 (TW) 100121027

(51) Int. Cl. G06F 3/048

(52) U.S. Cl. 715/765

(57) ABSTRACT

A user interface adjusting method for an electronic device is disclosed. The electronic device is capable of displaying a user interface including a plurality of selecting objects. The user interface adjusting method includes calculating amounts of the plurality of selecting objects being selected, and adjusting locations of the plurality of selecting objects within the user interface according to the amounts of the plurality of selecting objects being selected.

### BACKGROUND OF THE INVENTION

1. Field of the Invention

The present invention relates to a user interface adjusting method and electronic device using the same, and more particularly, to a user-interface adjusting method and electronic device capable of providing personalized configuration of selecting objects and enhancing convenience.

2. Description of the Prior Art

In a portable electronic device, such as portable computer, smart phone, Personal Digital Assistant (PDA) etc., a touch panel is widely used as a main input device, such that a user only needs to click selecting objects on the touch panel by a touch pen or a finger, to execute corresponding programs, application software, etc. However, these selecting objects are generally displayed as a matrix and arranged in fixed locations, which cannot be automatically changed to adapt to user's customs.

For example, please refer to FIG. 1, which is a schematic diagram of an operating frame 10 of a prior art smart phone. As shown in FIG. 1, the operating frame 10 includes multiple selecting objects each corresponding to a specific function, such as phone book, message, calendar, etc. In the prior art, each of the selecting objects is fixed in the same location corresponding to other selecting objects. If a user intends to change a location of a selecting object, the user has to perform related adjustment procedures, because the location cannot be automatically adjusted in response to user's customs. In addition, if the smart phone includes multiple operating frames, the user has to frequently switch the frames to find required selecting objects, which also causes inconvenience.

In short, the prior art user interface of the touch panel lacks personalization design, and cannot adjust the locations of the selecting objects in response to user's customs. Thus, improvement is required.

### SUMMARY OF THE INVENTION

It is therefore an object to provide a user interface adjusting method and electronic device using the same.

The present invention discloses a user interface (UI) adjusting method for an electronic device capable of displaying a UI comprising a plurality of selecting objects, which comprises calculating amounts of the plurality of selecting objects being selected; and adjusting locations of the plurality of selecting objects within the UI according to the amounts of the plurality of selecting objects being selected.

The present invention further discloses an electronic device, which comprises a processor; a touch panel; a user interface (UI), displayed on the touch panel, comprising a plurality of selecting objects; and a memory, for storing a program code, wherein the program code instructs the processor to executed the following steps: calculating amounts of the plurality of selecting objects being selected; and adjusting locations of the plurality of selecting objects within the UI according to the amounts of the plurality of selecting objects being selected.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an operating frame of a prior art smart phone.

FIG. 2 is a schematic diagram of a UI adjusting process in accordance with an embodiment of the present invention.

FIG. 3A and FIG. 3B are schematic diagrams illustrating a UI adjusted according to the UI adjusting process shown in FIG. 2.

FIG. 4A to FIG. 4C are schematic diagrams illustrating marks on adjusted locations of selecting objects.

FIG. 5 is a schematic diagram of a UI suitable for the UI adjusting process shown in FIG. 2.

FIG. 6 is a schematic diagram of a UI suitable for the UI adjusting process shown in FIG. 2.

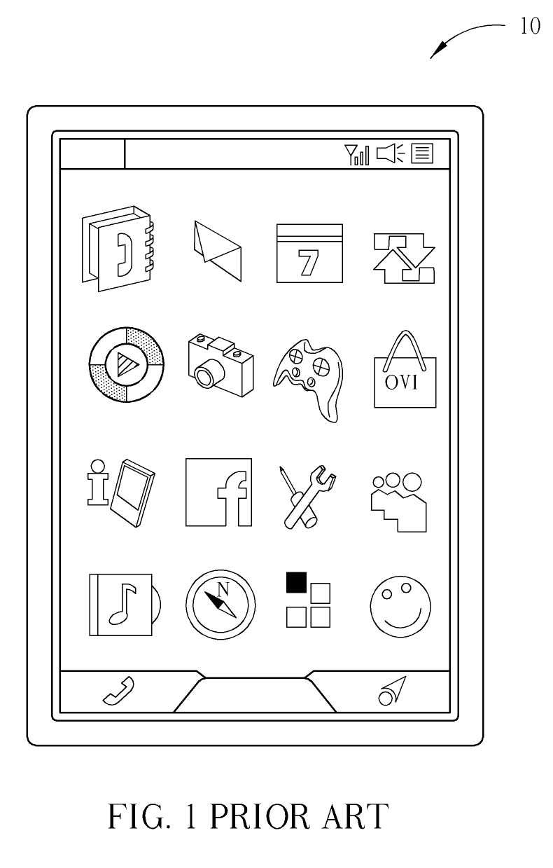

### DETAILED DESCRIPTION

As to a user interface (UI) of a touch panel, the present invention provides a method for automatically adjusting locations of selecting objects in response to user's customs, so as to provide personalized configuration of the selecting objects.

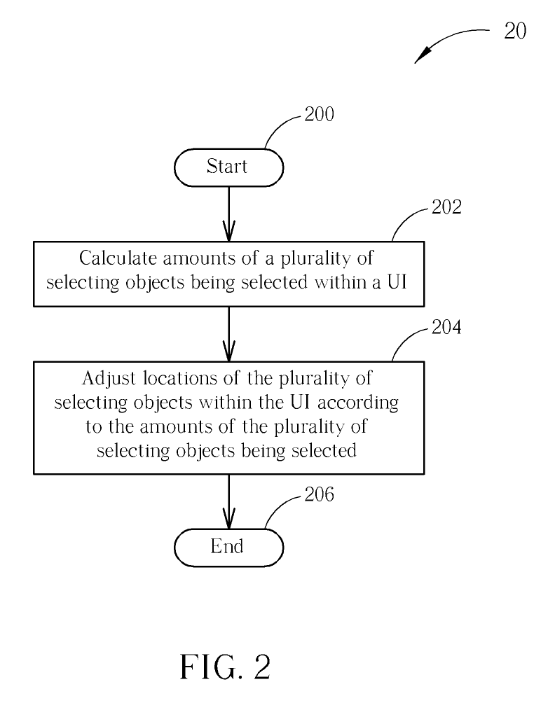

Please refer to FIG. 2, which is a schematic diagram of a UI adjusting process 20 in accordance with an embodiment of the present invention. The UI adjusting process 20 comprises the following steps:

Step 200: Start.

Step 202: Calculate amounts of a plurality of selecting objects being selected within a UI.

Step 204: Adjust locations of the plurality of selecting objects within the UI according to the amounts of the plurality of selecting objects being selected.

Step 206: End.

According to the UI adjusting process 20, the embodiment of the present invention adjusts the locations of the selecting objects according to the amounts of the selecting object being selected. In other words, as frequencies of using the selecting objects change, the UI adjusting process 20 can automatically adjust the locations of the selecting objects within the UI, so as to meet user's customs, and provide personalized configuration or arrangement of the selecting objects

Note that, the present invention is to consider the amounts of the selecting objects being selected and accordingly adjust the locations of the selecting objects within the UI, and those skilled in the art can readily make modifications. There are a variety of methods for calculating the amounts of the selecting objects being selected; for example, set a predefined period, such as three days, one week, etc., and calculate the amounts of the selecting objects being selected during the predefined period. In addition, noticeably, targets to be adjusted by the UI adjusting process 20 can be specific selecting objects determined by the user, and not all the selecting objects in the UI, in order to prevent affecting user's hobbies. In other words, the user can predefine which selecting objects should be changed locations in response to the amounts of being selected.

Moreover, the operating principle of step 204 can be modified according to system requirements, e.g. to move selecting objects frequently used to locations more easily hit. In other words, locations capable of setting the selecting objects within the UI are provided with priorities according to difficulty or convenience degrees of being selected or hit. If an amount of a selecting object being selected is greater than that of a selecting object located at a superior location (with higher priority), the locations of the two selecting objects are swapped. Also, the priorities of the locations can be predefined by the system, or determined by the user.

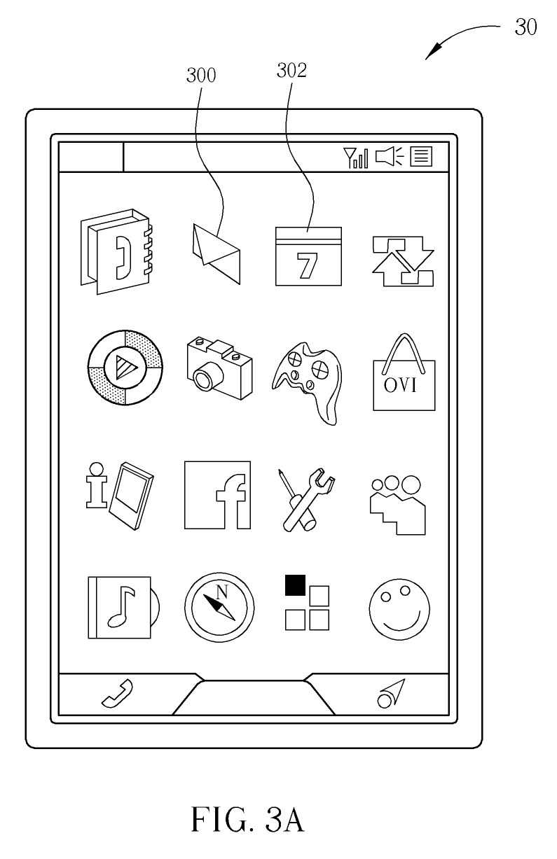

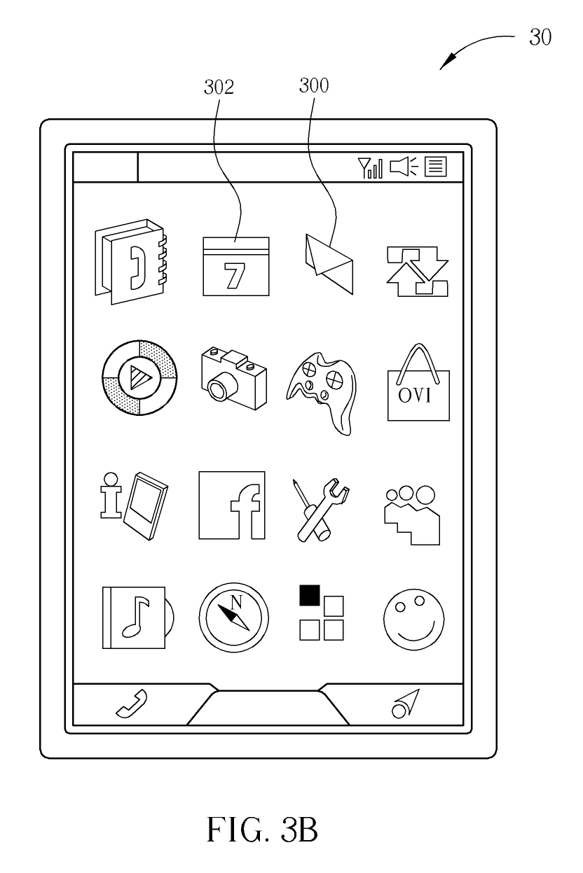

In detail, please refer to FIG. 3A and FIG. 3B, which are schematic diagrams illustrating a UI 30 adjusted according to the UI adjusting process 20. If the system predefines or the user determines that the left and upper corner of the UI 30 is the location with highest priority, and priorities are progressively decreased by columns and by rows. That is, in FIG. 3A, a location of a selecting object 300 is superior to that of a selecting object 302. If an amount of the selecting object 300 being selected during a specified period is smaller than that of the selecting object 302 being selected, then according to UI adjusting process 20, the embodiment of the present invention can swap the locations of the selecting objects 300 and 302, to put the selecting object 302 at a location with higher priority as shown in FIG. 3B.

FIG. 3A and FIG. 3B illustrate an example applying the UI adjusting process 20, and modifications can be made accordingly. For example, the priorities of the locations are not necessary to be progressively decreased between adjacencies; the central four locations can be set to be superior to outer locations. In addition, except calculating the selecting amounts during the predefined period, a threshold can be added. Take FIG. 3A as an example, the embodiment can be modified to start to adjust the locations of the selecting objects 300 and 302 when the amounts of the selecting objects 300 and 302 being selected (during the predefined period) are both greater than a predefined value, e.g. greater than 20 times during three days; oppositely, even if the amount of the selecting object 302 being selected is greater than that of the selecting object 300, the locations of the selecting objects 300 and 302 are kept, e.g. when the amount of the selecting object 302 being selected is 2, and the amount of the selecting object 300 being selected is 1. Alternatively, the embodiment can be modified to start to adjust the locations of the selecting objects 300 and 302 when a difference between the amounts of the selecting objects 300 and 302 being selected is greater than a buffer value. That is, when the buffer value is 5, the locations of the selecting objects 302 and 300 can be swapped if the difference between the amounts of the selecting objects 302 and 300 being selected is 5 (the former greater than the latter by 5).

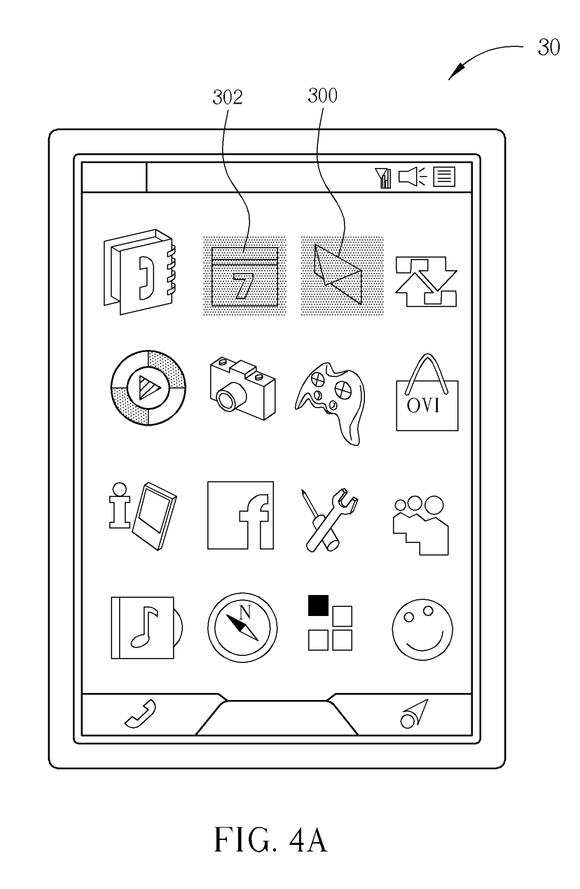

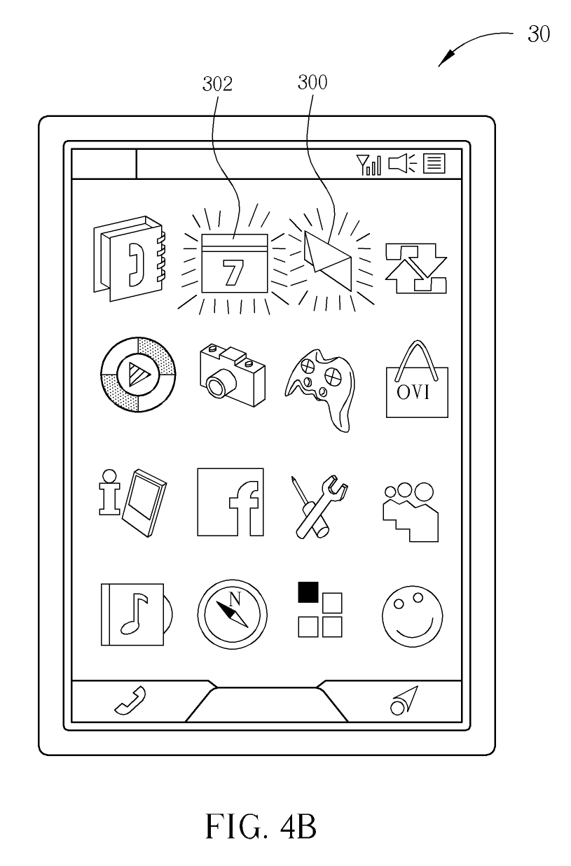

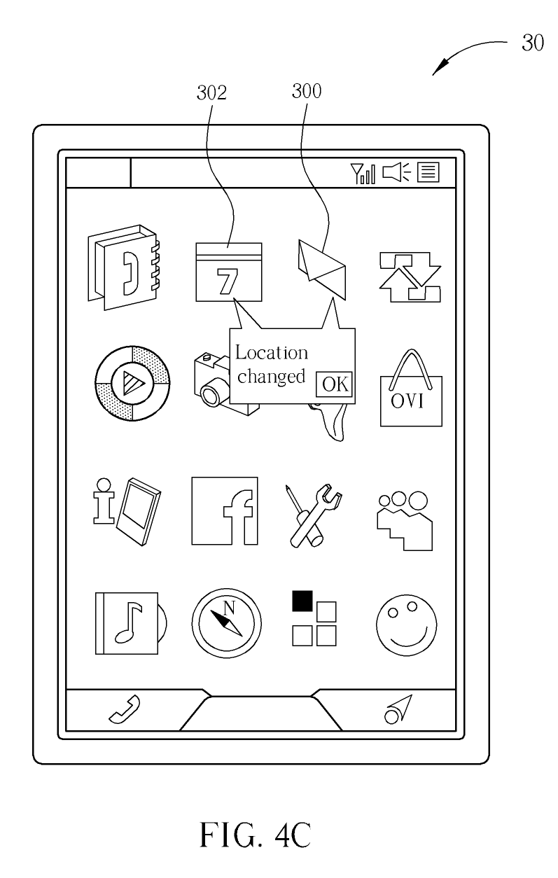

On the other hand, after step 204 adjusts the locations, the embodiment of the present invention can further output an indication message to indicate the status of the adjusted locations, and the indication message is not limited in any format. For example, continue with the example of FIG. 3A and FIG. 3B. After the locations of the selecting objects 300 and 302 are swapped, the embodiment of the present invention marks the swapped locations of the selecting objects 300 and 302 by reversing background color as shown in FIG. 4A, or by twinkling the selecting objects 300 and 302 as shown in FIG. 4B, or popping up a message window as shown in FIG. 4C.

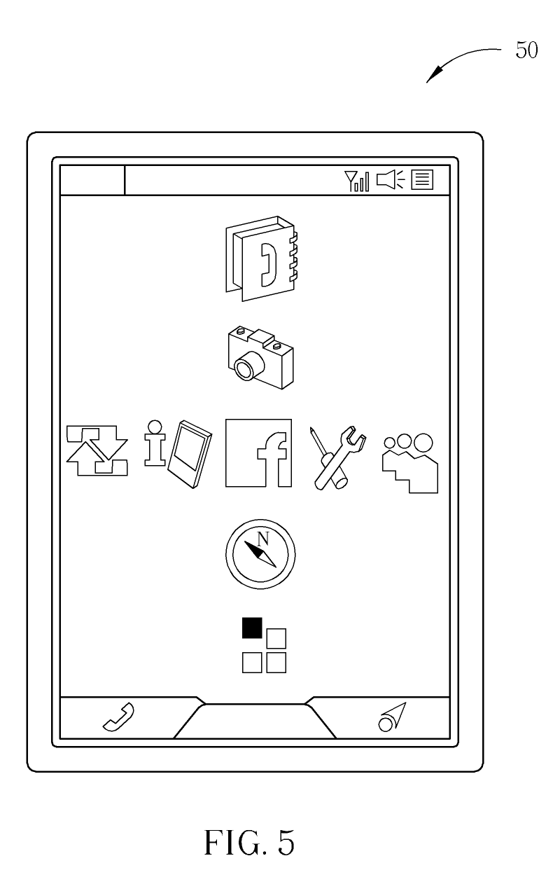

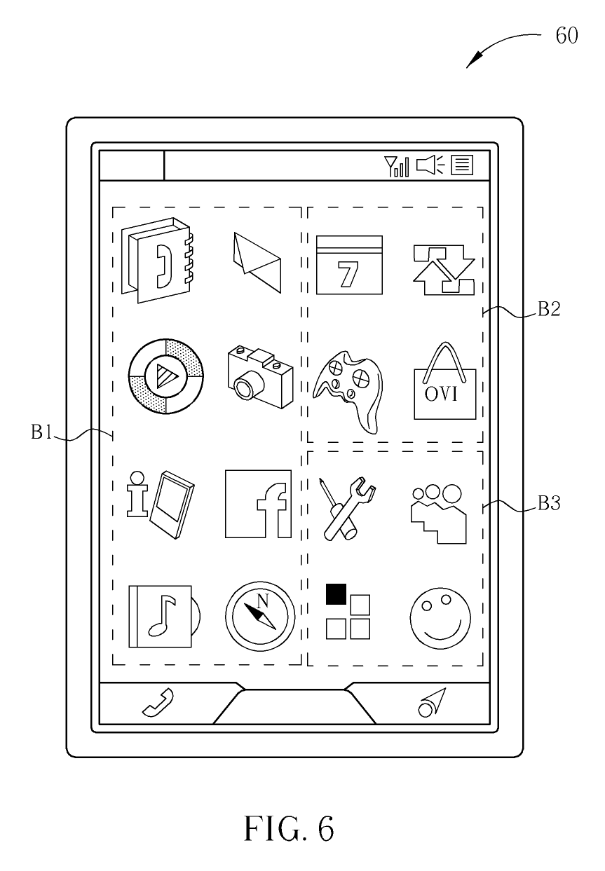

Furthermore, in the above description, the selecting objects of the UI 30 are arranged as a matrix. In fact, the present invention can apply to UIs with arbitrary shapes or formats. For example, FIG. 5 is a schematic diagram of a UI 50. Selecting objects of the UI 50 are arranged as a crisscross shape, whose locations can be adjusted by the UI adjusting process 20. In addition, the locations to be adjusted according to selecting times in the UI can further be divided into blocks. For example, FIG. 6 is a schematic diagram of a UI 60. The UI 60 comprises blocks B1, B2, B3, and locations of selecting objects of the blocks B1, B2, B3 are respectively adjusted. That is, a selecting amount of a selecting object within the block B1 is only compared with selecting amounts of other selecting objects within the block B1, and the selecting object can only be moved to another location within the block B1 if necessary. Adjustment of locations of the selecting objects within the block B2 or B3 is based on the same analogy.

As can be seen, the UI adjusting process 20 can automatically adjust locations of the selecting objects within UI according to user's customs, so as to provide personalized configuration of the selecting objects and enhance convenience. Besides, implementation of the steps of the UI adjusting process 20 should be well known by those skilled in the art. For example, the steps or modifications of the UI adjusting process 20 can be compiled into a program code by commands, parameters, variables, etc. of a program language, and stored in a memory of an electronic device, so as to instruct a processor of the electronic device to execute the corresponding steps, and adjust UI displayed on a touch panel.

In the prior art, each of the selecting objects displayed on the touch panel is fixed in the same location corresponding to other selecting objects; if a user intends to change a location of a selecting object, the user has to perform related adjustment procedures, because the location cannot be automatically adjusted in response to user's customs. In comparison, the present invention can automatically adjust locations of the selecting objects within UI according to user's customs, so as to provide personalized configuration of the selecting objects and enhance convenience.

In summary, the UI adjusting process of the present invention can provide personalized configuration of the selecting objects and enhance convenience.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A user interface (UI) adjusting method for an electronic device capable of displaying a UI comprising a plurality of selecting objects, comprising:
calculating amounts of the plurality of selecting objects being selected; and
adjusting locations of the plurality of selecting objects within the UI according to the amounts of the plurality of selecting objects being selected.

2. The UI adjusting method of claim 1, wherein the step of calculating the amounts of the plurality of selecting objects being selected is calculating the amounts of the plurality of selecting objects being selected during a predefined period.

3. The UI adjusting method of claim 1, wherein the step of adjusting the locations of the plurality of selecting objects within the UI according to the amounts of the plurality of selecting objects being selected comprises:
comparing amounts of a first selecting object and a second selecting object of the plurality of selecting objects being selected, wherein a first location of the first selecting object within the UI is superior to a second location of the second selecting object within the UI; and
arranging the first selecting object to the second location and arrange the second selecting object to the first location when the amount of the first selecting object being selected is smaller than that of the second selecting object being selected.

4. The UI adjusting method of claim 3, wherein the amounts of the first selecting object and the second selecting object being selected are greater than a predefined value.

5. The UI adjusting method of claim 3, wherein the amounts of the first selecting object and the second selecting object being selected are greater than a predefined value during a predefined period.

6. The UI adjusting method of claim 3, further comprising determining the amount of the first selecting object being selected is smaller than that of the second selecting object being selected when a sum of the amount of the first selecting object being selected and a buffer value is smaller than the amount of the second selecting object being selected.

7. The UI adjusting method of claim 1, further comprising outputting an indication message, to indicate a status of the adjusted locations of the plurality of selecting objects.

8. An electronic device, comprising:
a processor;
a touch panel;
a user interface (UI), displayed on the touch panel, comprising a plurality of selecting objects; and
a memory, for storing a program code, wherein the program code instructs the processor to executed the following steps:
calculating amounts of the plurality of selecting objects being selected; and
adjusting locations of the plurality of selecting objects within the UI according to the amounts of the plurality of selecting objects being selected.

9. The electronic device of claim 8, wherein the step of calculating the amounts of the plurality of selecting objects being selected is calculating the amounts of the plurality of selecting objects being selected during a predefined period.

10. The electronic device of claim 8, wherein the step of adjusting the locations of the plurality of selecting objects within the UI according to the amounts of the plurality of selecting objects being selected comprises:
comparing amounts of a first selecting object and a second selecting object of the plurality of selecting objects being selected, wherein a first location of the first selecting object within the UI is superior to a second location of the second selecting object within the UI; and
arranging the first selecting object to the second location and arrange the second selecting object to the first location when the amount of the first selecting object being selected is smaller than that of the second selecting object being selected.

11. The electronic device of claim 10, wherein the amounts of the first selecting object and the second selecting object being selected are greater than a predefined value.

12. The electronic device of claim 10, wherein the amounts of the first selecting object and the second selecting object being selected are greater than a predefined value during a predefined period.

13. The electronic device of claim 10, wherein the program code further instructs the processor to determine the amount of the first selecting object being selected is smaller than that of the second selecting object being selected when a sum of the amount of the first selecting object being selected and a buffer value is smaller than the amount of the second selecting object being selected.

14. The electronic device of claim 8, herein the program code further instructs the processor to output an indication message, to indicate a status of the adjusted locations of the plurality of selecting objects.
